(19) United States
(12) Patent Application Publication
(10) Pub. No.: US 2014/0115113 A1
(43) Pub. Date: Apr. 24, 2014

(54) METHOD AND APPARATUS FOR PORT FORWARDING

(71) Applicants: Garry M. Paxinos, Pompano Beach, FL (US); Anastasios Kyriakides, Hollywood, FL (US); Kenneth Alvin Hosfeld, Coral Spring, FL (US); Anastasios Nicholas Kyriakides, II, Plantation, FL (US)

(72) Inventors: Garry M. Paxinos, Pompano Beach, FL (US); Anastasios Kyriakides, Hollywood, FL (US); Kenneth Alvin Hosfeld, Coral Spring, FL (US); Anastasios Nicholas Kyriakides, II, Plantation, FL (US)

(21) Appl. No.: 14/057,412

(22) Filed: Oct. 18, 2013

Related U.S. Application Data
(60) Provisional application No. 61/715,521, filed on Oct. 18, 2012.

(51) Int. Cl. H04L 12/24

(52) U.S. Cl. CPC H04L 41/0803
USPC 709/219

(57) ABSTRACT

A method, apparatus and system to provide the ability for a user to grant permission and enable a technician or other entity to remotely access the user's computer networking device, such as a router, through an ATA or other electronic consumer device which is connected to the network provided by the computer networking device. The technician is then provided with the ability to access from a remote location the configuration and operation screens of the user's router and provide assistance related to the same. Permission to access the router through the electronic consumer device is granted by performing some local action on the electronic consumer device, such as pressing a specified button or dialing a code on the electronic consumer device or a device connected to the electronic consumer device.

### CROSS REFERENCE TO RELATED APPLICATIONS

This application claims the benefit of and incorporates by reference co-pending U.S. provisional patent application Ser. No. 61/715,521 filed Oct. 18, 2012.

### BACKGROUND OF THE INVENTION

1. Field of the Invention

This invention relates generally to electronic device networking and, more particularly, to a method and apparatus for facilitating remote administrator access to a computer networking device.

2. Description of the Prior Art

The use of computer networking devices, such as gateways, routers, switches bridges, hubs, and repeaters, to facilitate the use of a computer network (or “electronic data network” or “data network”) is well known. In recent times, computer networking devices, particularly routers, have become common equipment in the homes of end users. As routers have become more prevalent, it has also been observed that more and more electronic devices in an end users home are configured to connect to routers, enabling them to communicate with other devices in the home or over the Internet, and offer services which leverage such access to computer networks. In many cases, common household electronic devices depend on an active and available connection to a computer network to perform its primary intended functions. For example, whereas for decades many POTS telephones were able to provide telecommunications services simply through wired a connection to a PSTN, most contemporary VoIP telecommunications services can only be provided through a connection with a device, an analog telephone adapter (“ATA”) in some cases, having continuous access to an active connection to a computer network.

One problem which arises as a result of the increasing dependence of many household devices on access to an active connection to a computer network to perform desired functions is when computer network service is interrupted, such a household device may lose its ability to function as intended or desired. While it is known that interruptions in computer network service can originate anywhere along the network path, it is noted that an interruption in computer network service which is caused by an error in a computer networking device or other electronic equipment in an end user's dwelling can be particularly troubling to address systematically because such problems are individualized and widespread geographically by their very nature. And it is known to be not efficient for a service provider or other entity to provide in home service for every conceivable error and not effective (or time efficient) to attempt to walk through every end user troubleshooting steps to assist in self help. Thus, there remains a need for a method and apparatus which could facilitate remote administrator access to a computer networking device by port forwarding through an electronic device which is utilizing computer network services through the computer networking device. It would be helpful if such a port forwarding method and apparatus was structured to allow a user to selectively provide such remote access to a computer networking device. It would be additionally desirable for such a port forwarding method and apparatus to be structured to cause the remote administrator access automatically end or “time out” after the occurrence of preset criteria.

The Applicant's invention described herein provides for a method and apparatus adapted to remote administrator access to a computer networking device, enabling a technician to access the configuration and operations interfaces on an end user's remotely located computer networking device. The primary components in Applicants' port forwarding method and apparatus include a modified networked electronic device, a management system and a conventional computer networking device. When in operation, the port forwarding method and apparatus allows an end user to selectively provide to a remotely located technician administrator access to a computer networking device through an electronic device which is utilizing computer network services through the computer networking device. As a result, many of the limitations imposed by the prior art are removed.

### SUMMARY OF THE INVENTION

A method, apparatus and system to provide the ability for a user to grant permission and enable a Customer Service Representative (“CSR”), or other technician, to remotely access said user's computer networking device (in one embodiment, an Internet router) through an ATA or other electronic consumer device connected to the network provided by the computer networking device (“networked electronic device”).

A CSR is provided with the ability to request permission to access remotely the customer's router and/or firewall or other device connected to the network. The user may grant permission to access by the CSR or some other designated user by performing some local action, such as: (1) pressing a specified button on the ATA or other networked electronic device (may be a single button press, button press sequence, or some other manual input into the device); or dialing a predetermined number on a telephone connected to the ATA.

Through this action, the ATA provides the CSR with the ability to remotely access the user's router (or other computer networking device) configuration and operation screens—typically presented through a Web interface, as if the CSR was local and accessing the router from the user's ATA.

In one embodiment, the permission granted to the CSR to access “times out” after some defined limit after a period of non-use begins. For example, a time out may be associated with 15 minutes of the ATA no longer being used to access the router's configuration and operation screens.

It is an object of this invention to provide a method and apparatus which facilitates remote administrator access to a computer networking device by port forwarding through an electronic device which is utilizing computer network services through the computer networking device.

It is another object of this invention to provide a port forwarding method and apparatus structured to allow a user to selectively provide such remote access to a computer networking device.

It is yet another object of this invention to provide a port forwarding method and apparatus structured to cause the remote administrator access automatically end or “time out” after the occurrence of preset criteria.

These and other objects will be apparent to one of skill in the art.

### BRIEF DESCRIPTION OF THE DRAWINGS

FIG. 1 shows the main components of a port forwarding method and apparatus according to one embodiment of the present invention.

FIG. 2 shows a top plan view of ATA configured for port forwarding in accordance with an embodiment of the present invention.

FIG. 3 shows a top plan view of ATA configured for port forwarding in accordance with another embodiment of the present invention.

FIG. 4 shows a process for establishing and operating a port forwarding session in accordance with the present invention.

### DETAILED DESCRIPTION OF THE INVENTION

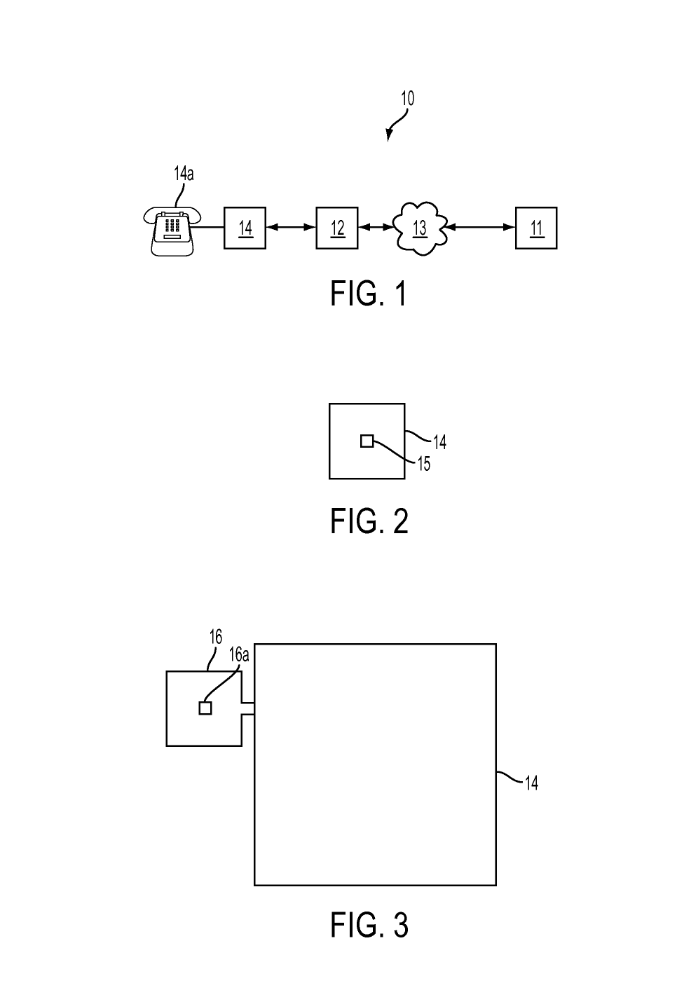

Referring now to the drawings and in particular FIG. 1, the primary components of a port forwarding method and apparatus include a networked electronic device, a computer networking device, and a management system 11. In one embodiment, the computer networking device is a router 12 which is connected directly or indirectly (i.e., through a modem) to the Internet 13 to enable other devices to access the Internet 13 through a connection to the router 12. In other embodiments, the computer networking device is any conventional computer networking device through which the Internet 13 can be accessed.

In one embodiment, the networked electronic device is an ATA 14 which is adapted to access the Internet 13 through a connection to the router 12 in its normal, VoIP enabling operation and configured for port forwarding to in accordance with the present invention. The ATA 14 is shown connected to an analog telephone 14a in accordance with its role in the provision of VoIP services. In addition to configuration for its customary functions, an ATA 14 built in accordance with the present invention is additional configured for port forwarding through the addition of hardware and/or software components which allow it to provide proxy server functions, identify and process electronic communications from the management system 11, and receive user input by way of a manual actuator and/or electronic data representing the entry of a code.

It other embodiments, is contemplated that any networked electronic device which is configured for port forwarding, through hardware and/or software components, in accordance with the present invention may be utilized in an equivalent manner as the ATA 14 to enable port forwarding. For example, in one embodiment a set top box which is adapted to access the Internet through a router may be utilized to enable port forwarding if it were configured through hardware and/or software components, to provide proxy server functions, identify and process electronic communications from the management system 11, and receive user input by way of a manual actuator and/or electronic data representing the entry of a code.

The management system 11 is a remotely located computer system which is connected to the Internet 14 and configured to communicate data with the ATA 14. It is contemplated that in typical scenarios, the management system 11 will be operated by customer service representative or other technicians having an objective of assisting from a remote location a user of a router 12 in troubleshooting the router 12 as it is disposed and used locally by said user.

Referring now to FIGS. 1 and 2, the exterior an ATA 14 built in accordance with one embodiment the present invention will include an actuator button 15. It is contemplated that the configuration in FIG. 2 would be utilized in an ATA 14 which was configured for port forwarding as manufactured, thus containing the internal hardware and/or software which configure the ATA 14 for port forwarding. The actuator button 15 provides a manual user interface through which a user can initiate a port forwarding process by performing a permission action. A permission action causes the ATA 14 to initiate its proxy server activity on behalf of the management system 11, enabling it to receive client requests from the management system 11, fulfill the request, and the send information related to the request to the management system 11. In one embodiment, a permission action is defined by engaging the manual actuator button. In one embodiment, a permission action is defined by cause a preset code to be entered on the ATA 14. In this embodiment, a user may engage the manual actuator button 15 or cause a preset code to be entered on the ATA 14 and port forwarding functions through the ATA 14 will be availed.

Referring now to FIGS. 1 and 3, the exterior an ATA 14 built in accordance with one embodiment the present invention will include an USB plug 16. It is contemplated that the configuration in FIG. 3 would be utilized in an ATA which was configured for port forwarding subsequent to its manufacture. The USB plug 16 supplements the ATA 14's existing hardware and software with the requisite hardware and/or software which configure the ATA 14 for port forwarding. In one embodiment, the USB plug additionally includes an actuator button 16a to provide a manual user interface through which a user can initiate a port forwarding process by performing a permission action. In this embodiment, a user may engage the manual actuator button 16a or cause a preset code to be entered on the ATA 14 and port forwarding functions through the ATA 14 will be availed.

It is contemplated that in other embodiments, an ATA may be configured for port forwarding and operate in accordance with the present invention through software downloads and updates over a computer network, in addition or in the alternative to a USB plug.

In an alternate embodiment, a permission action can be caused remotely, either by the transmission of particular electronic data over the Internet by the management system 11 or other electronic device. In another alternate embodiment, a permission action can be caused automatically upon a present condition being met, such as the detection of an alteration in the hardware and/or software of the ATA 14.

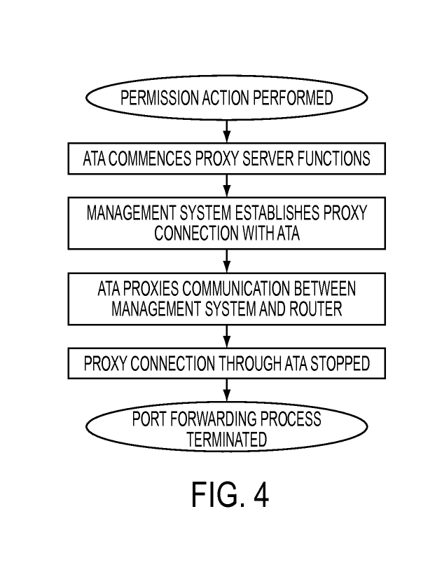

Referring now to FIG. 4, the process of initiating a port forwarding session begins with the performance of a permission action. In one embodiment, a local, manual action, such as engaging an actuator on an ATA built in accordance with the present invention or causing a code to be entered on such an ATA through a connected telephone define a permission action. In typical circumstances, a user will perform a permission action at the request of a technician seeking to provide technical assistance on the user's router.

Once a permission action is performed, the ATA enables proxy server functionality, enabling it to receive client requests from an remote device over an Internet connection (the connection being made through a router) verify the remote device as an authorized client, fulfill the request, and the send information related to the request to the requesting client. In some embodiments, the ATA additionally the notifies by way of an electronic message the remote client, defined as a management system in one embodiment of the present invention, that the proxy functionality is operational.

The management system then established a proxy connection with the ATA and through the proxy, begins accessing the device configuration and operation interfaces of the router through which the ATA is connected to the Internet. Because the router recognizes the access attempt as coming from the ATA (and it is coming from the ATA, though on behalf of the management system), the device configuration and operation interfaces of the router can be accessed and manipulated in the same manner in which any locally disposed device which is connected to the router can. Provided login credentials can be supplied, this includes administrator access.

Once the management system no longer requires access to the router, or once the user no longer desires to provide remote access to the router, the proxy connection is stopped. The proxy connection can be stopped by manual action, such as the performance of a permission action while port forwarding is active. This includes the ability for the proxy connection to be stopped by a command or other action from the management system. In addition, in one embodiment, the ATA is configured to “time out” access granted after the expiration of a defined time period of non-use. In one embodiment, such a time out occurs once there has been 15 minutes of non-use of the proxy server function.

In one embodiment, the ATA is able to provide proxy server functionality while still providing is customary functionality provided sufficient bandwidth is available, enabling a user to speak to a customer service representation or technician while the technician is accessing the user's router.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for port forwarding, comprising the steps of:
providing a networked electronic device configured for port forwarding and connected to an electronic data network through a computer networking device;
providing a management system disposed in a remote location relative to said networked electronic device, wherein said management system is configured to communicate electronic data with said networked electronic device over said electronic data network;
selectively causing said networked electronic device to commence proxy server functions, enabling said networked electronic device to receive client requests from said management system over the electronic data network, fulfill the request, and the send information related to the request to the said management system; and
accessing by said management system the configuration interface of the computer networking device through the function of the networked electronic device proxy server.

2. The method of claim 1, wherein said computer networking device is a router.

3. The method of claim 1, wherein said networked electronic device is an ATA.

4. The method of claim 3, wherein said ATA is additionally connected to a telephone.

5. The method of claim 4, wherein the step of selectively causing said networked electronic device to commence proxy server functions is actuated by dialing a predetermined sequence of numbers on the telephone.

6. The method of claim 3, wherein the step of selectively causing said networked electronic device to commence proxy server functions is actuated by engaging a manual actuator.

7. The method of claim 1, wherein the step of selectively causing said networked electronic device to commence proxy server functions includes enabling said networked electronic device to verify the management system as an authorized client.

8. The method of claim 1, additionally comprising the step of causing said networked electronic device to terminate proxy server functions.

9. The method of claim 8, wherein said step of selectively causing said networked electronic device to terminate proxy server functions occurs automatically with the passing of a preset time period of non-use of the proxy server function.

10. A method for port forwarding, comprising the steps of:
providing a management system configured to communicate electronic data over a electronic data network with at least one networked electronic device, wherein said networked electronic device is disposed remotely relative to said management system and connected to the electronic data network through a computer networking device; and
accessing by said management system the configuration and operation interfaces of the computer networking device through the function of the networked electronic device, wherein said networked electronic device is configured to receive client requests from said management system over the electronic data network, fulfill the request, and the send information related to the request to the said management system.

11. A system for port forwarding, comprising:
a networked electronic device configured for port forwarding and connected to an electronic data network through a computer networking device;
a management system disposed in a remote location relative to said networked electronic device, wherein said management system is configured to communicate electronic data with said networked electronic device over said electronic data network;
wherein said networked electronic device is caused to selectively to commence proxy server functions, enabling said networked electronic device to receive client requests from said management system over the electronic data network, fulfill the request, and the send information related to the request to the said management system; and
wherein said management system accesses the configuration interface of the computer networking device through the function of the networked electronic device proxy server.

12. The system of claim 11, wherein said computer networking device is a router.

13. The system of claim 11, wherein said networked electronic device is an ATA.

14. The system of claim 13, wherein said ATA is additionally connected to a telephone.

15. The system of claim 14, wherein selectively causing said networked electronic device to commence proxy server functions is actuated by dialing a predetermined sequence of numbers on the telephone.

16. The system of claim 13, wherein selectively causing said networked electronic device to commence proxy server functions is actuated by engaging a manual actuator.

17. The system of claim 11, wherein selectively causing said networked electronic device to commence proxy server functions includes enabling said networked electronic device to verify the management system as an authorized client.

18. The system of claim 11, wherein said networked electronic device is caused to terminate proxy server functions.

19. The system of claim 18, wherein the termination of proxy server functions occurs automatically with the passing of a preset time period of non-use of the proxy server function.

20. The system of claim 18, wherein the termination of proxy server functions occurs as a result of a request from the management system.
